(19) United States
(12) Patent Application Publication
(10) Pub. No.: US 2024/0267077 A1
(43) Pub. Date: Aug. 8, 2024

(54) TRANSCEIVING DEVICE

(71) Applicant: Rohm Co., Ltd., Kyoto (JP)

(72) Inventor: Koji Terumoto, Kyoto (JP)

(21) Appl. No.: 18/523,074

(22) Filed: Nov. 29, 2023

(30) Foreign Application Priority Data
Feb. 6, 2023 (JP) 2023-016150

(51) Int. Cl. H04B 1/40; H01Q 23/00

(52) U.S. Cl. CPC H04B 1/40; H01Q 23/00

(57) ABSTRACT

The present disclosure provides a transceiving device. The transceiving device includes: a modulated signal generating unit, configured to generate a modulated signal; a transmitting unit, configured to be driven by the modulated signal; a receiving unit, configured to receive a transmission signal transmitted from the transmitting unit; and a crystal filter, configured to receive a receiving signal output from the receiving unit and including a crystal resonator. The modulated signal is a sweep signal that changes between a predetermined first frequency higher than a resonant frequency of the crystal filter and a predetermined second frequency lower than the resonant frequency.

### TECHNICAL FIELD

The present disclosure relates to a transceiving device.

### BACKGROUND

Conventionally, large-capacity communication or signal processing, imaging or measurement is attempted using electromagnetic waves in a frequency range of 0.1 THz to 10 THz, which is called a terahertz band. The frequency range above attends to both properties of light and electric waves. If a device operating under this frequency band is achieved, the device can be used for numerous purposes such as measurement in various fields including physical properties, astronomy and biology, in addition to imaging, large-capacity communication and information process stated above.

As an element for generating or receiving electromagnetic waves in a frequency of the megahertz waveband, for example, an element including a structure integrated with a resonant tunneling diode (RTD) and a micro-slot antenna is known (for example, refer to patent document 1).

### PRIOR ART DOCUMENT

### Patent Publication

[Patent document 1] Japan Patent Publication No. 2016-111542

### BRIEF DESCRIPTION OF THE DRAWINGS

FIG. 1 is a diagram of a configuration of a transceiving device of a comparison example.

FIG. 2 is a diagram for illustrating a 1/f noise.

FIG. 3 is a diagram of an example of a modulated signal.

FIG. 4 is a diagram of a configuration example of direct-current (DC) bias circuit.

FIG. 5 is a diagram of an example of a special case of a band-pass filter (BPF).

FIG. 6 is a diagram of a configuration of a transceiving device according to a first embodiment of the present disclosure.

FIG. 7 is a diagram of an example of characteristics of a crystal filter.

FIG. 8 is a diagram of an example of changes in a frequency of a modulated signal.

FIG. 9 is a diagram of waveforms of signals on a receiving side in a comparison example and an embodiment of the present disclosure.

FIG. 10 is a diagram for illustrating effects of an embodiment of the present disclosure.

FIG. 11 is a diagram of a configuration example of a transceiving device according to a second embodiment of the present disclosure.

FIG. 12 is a diagram of a configuration example of a transceiving device according to a third embodiment of the present disclosure.

FIG. 13 is a brief diagram of examples of waveforms of a modulated signal and a receiving signal according to the third embodiment of the present disclosure.

FIG. 14 is a diagram of a configuration example of a transceiving device according to a fourth embodiment of the present disclosure.

FIG. 15 is a diagram of a configuration example of an envelope detection circuit.

FIG. 16 is a diagram of an example of an envelope detection.

FIG. 17 is a diagram of a variation example of a transceiving device according to the fourth embodiment of the present disclosure.

### DETAILED DESCRIPTION OF THE EMBODIMENTS

Details of the exemplary embodiments are provided with reference to the accompanying drawings below.

### 1. Comparison Example

Before describing the embodiments of the present disclosure, a comparison example is described below. Issues can become more apparent with the description of the comparison example.

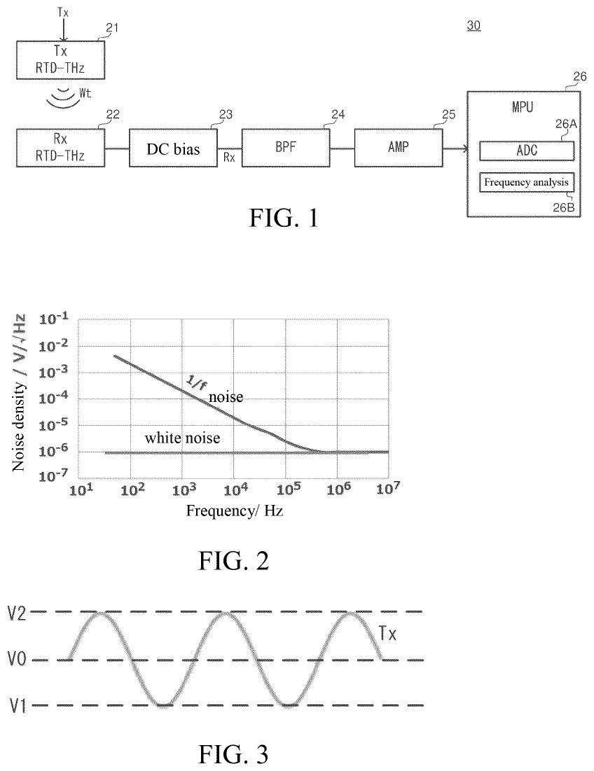

FIG. 1 shows a diagram of a configuration of a transceiving device 30 of the comparison example. The transceiving device 30 shown in FIG. 1 includes a transmitting unit 21 on a transmitting side, and a receiving unit 22, a DC bias circuit 23, a band-pass filter (BPF) 24, an amplifier 25, and a microprocessing unit (MPU) 26 on a receiving side. Moreover, the transceiving device 30 can be, for example, a reflective type configuration in which a transmission signal Wt output from the transmitting unit 21 is reflected by an object and received by the receiving unit 22, or a transmissive type configuration in which the transmission signal Wt output from the transmitting unit 21 passes through the object and is received by the receiving unit 22.

The transmitting unit 21 is a chip package in which a resonant tunneling diode (RTD) and a micro-slot antenna are formed on a substrate. A modulated signal Tx is applied to the RTD. The modulated signal Tx is a sine wave signal or a square wave signal. Considering a 1/f noise as shown in FIG. 2, a frequency (modulation frequency) of the modulated signal Tx is set to, for example, 1 MHz which is relatively high.

Moreover, as shown in FIG. 3, in the modulated signal Tx, a lower limit voltage V1 is set to a voltage at which the terahertz wave does not transmit and a upper limit voltage V2 is set to a voltage at which the terahertz wave transmits by using a bias voltage V0 as a center. On or off driving is performed on the transmitting unit 21 by applying the modulated signal Tx, and the transmission signal (transmission wave) Wt in a terahertz band is output from the transmitting unit 21.

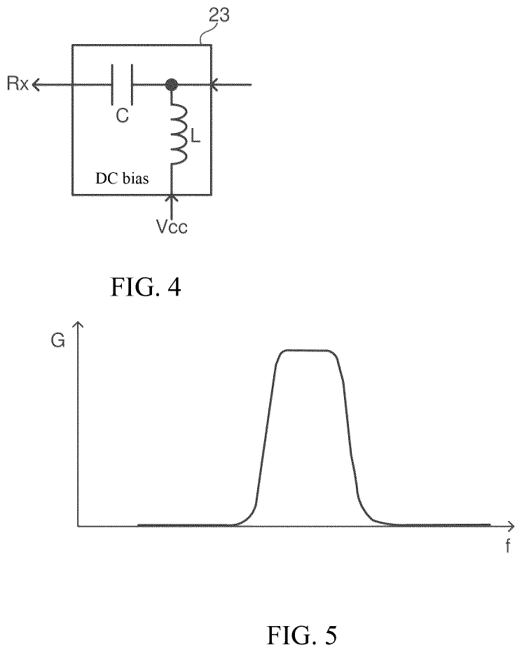

Similar to the transmitting unit 21, the receiving unit 22 is a chip package in which an RTD and a micro-slot antenna are formed on a substrate. The transmission signal Wt is received by the micro-slot antenna. The DC bias circuit 23 is connected between the receiving unit 22 and the BPF 24. As shown in FIG. 4, the DC bias circuit 23 includes an inductor L and a capacitor C. A DC voltage Vcc is supplied to the RTD in the receiving unit 22 via the inductor L. An alternating-current (AC) signal output from the receiving unit 22 is output to the BPF 24 as a receiving signal Rx via the capacitor C. The capacitor C cuts off the DC voltage Vcc.

The BPF 24 is, for example, a filter which has a filter characteristic which is a relation between a frequency f and a gain G in FIG. 5 and hence allows a signal with a predetermined band to pass through, and allows a signal with the frequency of the modulated signal Tx to pass through so as to remove noise. The BPF 24 is an analog circuit implemented by such as an LCR (an electrical bridge) or an operational amplifier.

A signal passing through the BPF 24 is amplified by the amplifier 25 and output to the MPU 26. The MPU 26 includes an analog-to-digital converter (ADC) 26A which analog-to-digital converts an output from the amplifier 25, and a frequency analysis unit 26B which performs frequency analysis such as fast Fourier transform (FFT) on the analog-to-digital converted signal. A power spectral value of the frequency of the modulated signal Tx obtained by the frequency analysis unit 26 is treated as a signal strength (a strength of a sensing signal of a sensor) on the receiving side.

However, in the configuration of the comparison example, the following issue is generated. First of all, in order to improve an SNR of a signal on the receiving side, the BPF 24 needs to be configured as a high-order filter if a steep characteristic that narrows the frequency band for a signal to pass in the BPF 24 is desired, such that the number of components as well as a circuit scale are increased. Moreover, as described above, since the frequency of the modulated signal Tx is set to 1 MHz which is relatively high in order to suppress influences of the 1/f noise, a load (for example, current consumption and memory capacity) of signal processing in the MPU 26 is increased.

### 2. First Embodiment

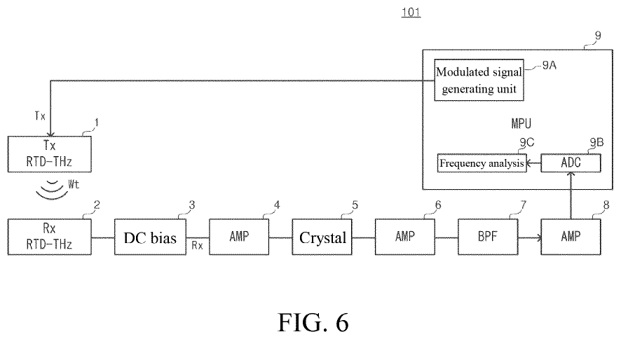

FIG. 6 shows a diagram of a configuration of a transceiving device 101 according to a first embodiment of the present disclosure. The transceiving device 101 includes a transmitting unit 1 on a transmitting side, and a receiving unit 2, a DC bias circuit 3, an amplifier 4, a crystal filter 5, an amplifier 6, a BPF 7 and an amplifier 8 on a receiving side. The transceiving device 101 further includes an MPU 9. The MPU 9 includes a modulated signal generating unit 9A, an ADC 9B and a frequency analysis unit 9C. Similar to the comparison example, the transceiving device 101 is configured to be a reflective type or a transmissive type.

The modulated signal generating unit 9A is configured to generate a modulated signal Tx. The modulated signal Tx generated is applied to the transmitting unit 1. The transmitting unit 1, the receiving unit 2 and the DC bias circuit 3 are configured to be the same as those of the comparison example. The modulated signal Tx is a sine wave signal or a square wave signal. Moreover, similar to the comparison example, as shown in FIG. 3, in the modulated signal Tx, by using a bias voltage V0 as a center, a lower limit voltage V1 is set to a voltage at which a terahertz wave is not transmitted, and a upper limit voltage V2 is set to a voltage at which a terahertz wave is transmitted. On or off driving is performed on the transmitting unit 1 by applying the modulated signal Tx, and the transmission signal (transmission wave) Wt in a terahertz band is output from the transmitting unit 1.

Similar to the comparison example, the transmission signal Wt is received by the receiving unit 2, and a receiving signal Rx output from the receiving unit 2 is input to the amplifier 4 via the DC bias circuit 3. The receiving signal Rx is amplified by the amplifier 4 and input to the crystal filter 5.

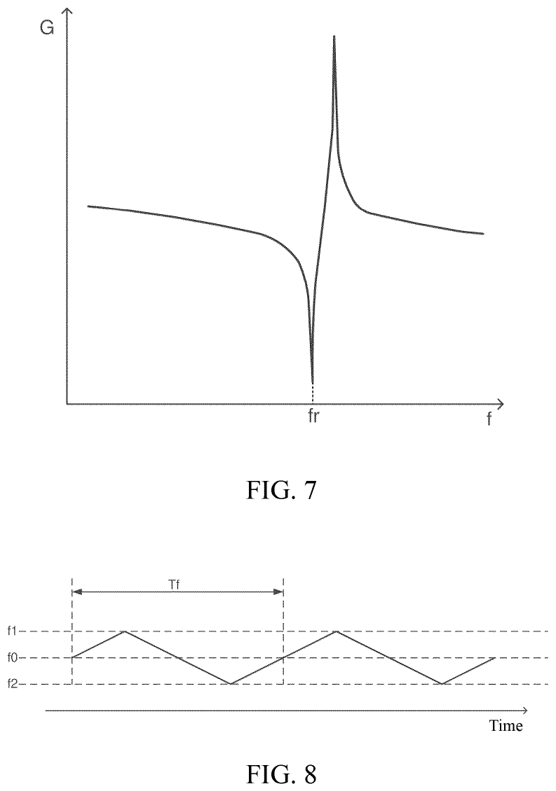

The crystal filter 5 is, for example, implemented by a single crystal resonator. The crystal filter 5 has a filter characteristics which is a relation between a frequency f and a gain G as shown in FIG. 7. As shown in FIG. 7, the crystal filter 5 has a resonant frequency fr and a higher Q value, and a band of a signal passing through is narrower. Accordingly, the crystal filter 5 reduces the number of components of the configuration, and has an outstanding characteristic in terms of removing useless frequency components.

A signal passing through the crystal filter 5 is amplified by the amplifier 6 and input to the BPF 7. The BPF 7 is a low-pass filter provided for anti-aliasing. A signal passing through the BPF 7 is amplified by the amplifier 8 and input to the ADC 9B. The signal input to the ADC 9B is analog-to-digital converted by the ADC 9B, and undergoes frequency analysis by the frequency analysis unit 9C.

Since the crystal filter 5 has the steep filter characteristic as described above, assuming that the frequency of the modulated signal Tx is set to a fixed frequency, a signal passing through the crystal filter 5 is attenuated and the SNR is lowered because the frequency characteristic of the transmitting unit 1 is deviated or a because frequency offset is caused due to temperature characteristics. Thus, in this embodiment, the modulated signal generating unit 9A generates the modulated signal Tx as a sweep signal with changes in the frequency.

FIG. 8 shows a diagram of an example of changes in the frequency of the modulated signal Tx. In the example shown in FIG. 8, in one cycle Tf, the frequency of the modulated signal Tx changes linearly from a central frequency f0 to a first frequency f1 higher than the central frequency f0, changes linearly through the central frequency f0 to a second frequency f2 lower than the central frequency f0, and then changes linearly to the central frequency f0. The central frequency f0 is set to be equal to the resonant frequency of the crystal filter 5. The resonant frequency fr is, for example, 60 kHz. When the modulated signal Tx, for example, is f0=60 kHz and changes within a sweep range of 60 kHz±1%, f1=60.6 kHz and f2=59.4 kHz. Since f0=60 kHz, Tf is set to be substantially equal to 1/100 of f0, for example, a cycle of 1 kHz. In the MPU 9, a power spectral value of the frequency of the modulated signal Tx obtained by the frequency analysis unit 9C is treated as a signal strength on the receiving side. More specifically, for example, the power spectral value under f0 can be treated as a signal strength, or a peak of the power spectral value can be treated as a signal strength.

As such, in this embodiment, with the reduced number of components and the steep filter characteristics implemented by the use of the crystal filter 5 on the receiving side, the SNR on the receiving side can be improved even in the event of a characteristic deviation on the transmitting side. Moreover, the frequency of the modulated signal Tx can be set to a lower value, and so a processing load in the MPU 9 can be suppressed.

Moreover, the central frequency f0 is not necessarily the resonant frequency fr, given that the sweep range includes the resonant frequency fr.

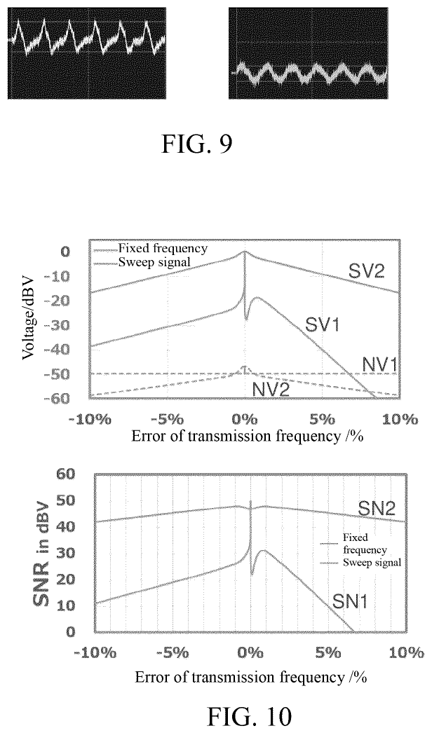

Herein, the left of FIG. 9 indicates an example of a waveform of an output of the amplifier 25 of the comparison example (FIG. 1), the sine wave is askew, and frequency components outside the frequency of the modulated signal Tx are also included. On the other hand, the right of FIG. 9 indicates an example of a waveform of an output of the amplifier 8 of this embodiment, the sine wave is less askew, and a waveform including the frequency of the modulated signal Tx as a main component is obtained. Accordingly, the SNR of this embodiment is improved in comparison with that of the comparison example.

Moreover, the top of FIG. 10 indicates an example of a relation of errors of a signal strength SV1 and a noise strength NV1 with respect to a predetermined frequency (equivalent to the resonant frequency fr of the crystal filter 5 and is, for example, 60 kHz herein) when the frequency of the modulated signal Tx is set to a fixed frequency in a configuration of this embodiment. Moreover, the top of FIG. 10 indicates an example of a relation of sweep ranges of a signal strength SV2 and a noise strength NV2 when the modulated signal Tx is set as a sweep signal in a configuration of this embodiment. Moreover, when the sweep range is set to f0±α % (f0=fr, and is 60 kHz herein), the horizontal axis of FIG. 10 represents ±α %. Moreover, in FIG. 10, the signal strength is that when a metal target is arranged in a reflective configuration, and the noise strength is that when no target is arranged in a reflective configuration, that is, when there are no reflected waves.

Moreover, the bottom of FIG. 10 indicates an SNR SN1 when the frequency of the modulated signal Tx is set to a fixed frequency and an SNR SN2 when the modulated signal Tx is set as a sweep signal. The bottom of FIG. 10 is a result corresponding to the top of FIG. 10.

Thus, when the frequency of the modulated signal Tx is set to a fixed frequency, the signal strength is significantly attenuated and the SNR is also significantly reduced if a slight deviation occurs from the resonant frequency fr of the crystal filter 5. In contrast, when the modulated signal Tx is set as a sweep signal, the signal strength is attenuated and the SNR is reduced as the sweep range increases, with however the decrease in the SNR being significantly suppressed.

### 3. Second Embodiment

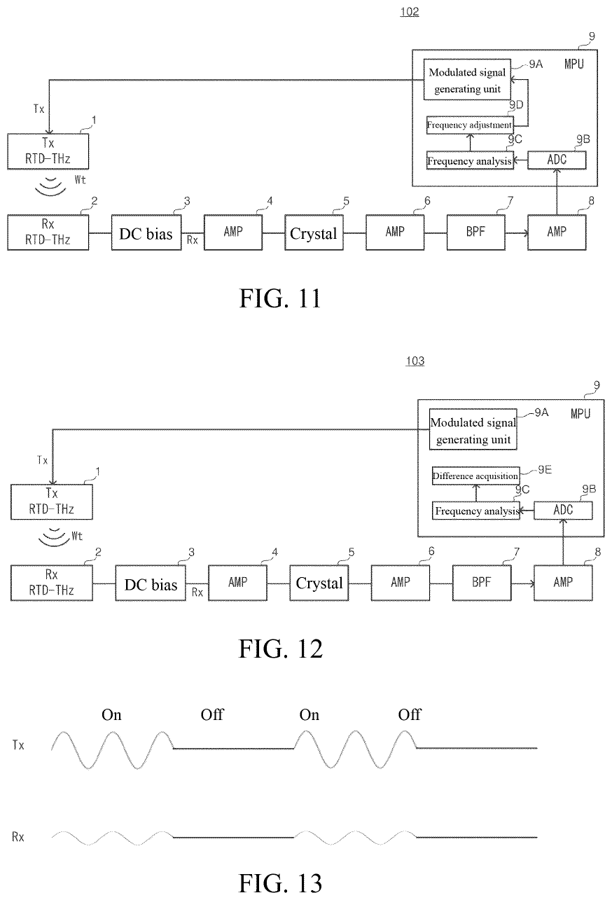

FIG. 11 shows a diagram of a configuration of a transceiving device 102 according to a second embodiment of the present disclosure. The transceiving device 102 of this embodiment differs from the first embodiment (FIG. 6) in respect of the configuration of the MPU 9. More specifically, a frequency adjustment unit 9D is provided in the MPU 9.

In the configuration of FIG. 11, first of all, the modulated signal generating unit 9A generates a modulated signal Tx as a sweep signal having a frequency of f0±α % and drives the transmitting unit 1, analog-to-digital converts an output of the amplifier 8 by the ADC 9B on the receiving side, and performs frequency analysis by the frequency analysis unit 9C. Herein, the frequency adjustment unit 9D detects a deviation from the frequency f0 for a frequency at which a power spectral value is obtained by the frequency analysis as a peak, and adjusts f0 based on the deviation. Next, the modulated signal generating unit 9A generates the modulated signal Tx based on the adjusted f0, as a sweep signal with a frequency of f0±β %, and drives the transmitting unit 1. Wherein, it is set that β<α to reduce the sweep range. Accordingly, on the receiving side, the power spectral value of the frequency of the modulated signal Tx obtained by the frequency analysis unit 9C is treated as a signal strength

For example, when f0=60 kHz (the resonant frequency fr of the crystal filter 5) in a first round of measurement (transceiving), the deviation is 1 kHz because the frequency of the power spectral value obtained by frequency analysis as a peak is 61 kHz, and thus it is set that f0=59 kHz in a second round of measurement.

Accordingly, in this round of measurement, that is, the second round of measurement, measurement with an improved SNR can be performed. Moreover, if it is set that β=0, it is equivalent that the frequency of the modulated signal Tx is set to a fixed frequency and the SNR can be further improved.

### 4. Third Embodiment

FIG. 12 shows a diagram of a configuration of a transceiving device 103 according to a third embodiment of the present disclosure. The transceiving device 103 of this embodiment differs from the first embodiment (FIG. 6) in respect of the configuration of the MPU 9. More specifically, a difference acquisition unit 9E is provided in the MPU 9.

In this embodiment, as shown by an example of a brief waveform in FIG. 13, the modulated signal generating unit 9A turns on and off the modulated signal Tx. Then, a first frequency analysis result is obtained by performing frequency analysis using the frequency analysis unit 9C for a part of the receiving signal Rx corresponding to an ON part of the modulated signal Tx, while a second frequency analysis result is obtained by performing frequency analysis using the frequency analysis unit 9C for a part of the receiving signal Rx corresponding to an OFF part of the modulated signal Tx. Moreover, the difference acquisition unit 9E obtains a difference between a power spectral value of a frequency of the modulated signal Tx according to the first frequency analysis result and a power spectral value of a frequency of the modulated signal Tx according to the second frequency analysis result, as a signal strength.

Accordingly, a signal strength in a de-noised state can be obtained.

### 5. Fourth Embodiment

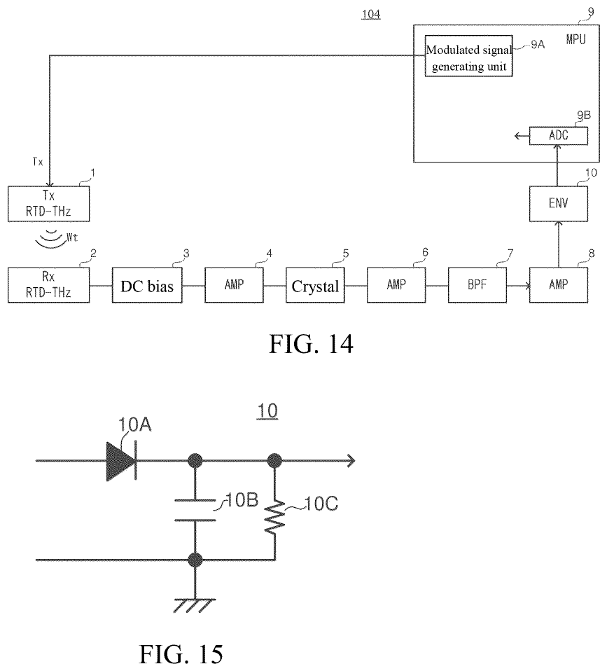

FIG. 14 shows a diagram of a configuration of a transceiving device 104 according to a fourth embodiment of the present disclosure. The transceiving device 104 of this embodiment differs from the first embodiment (FIG. 6) in that, an envelope detection circuit 10 is provided, and the MPU 9 is not provided with any frequency analysis unit.

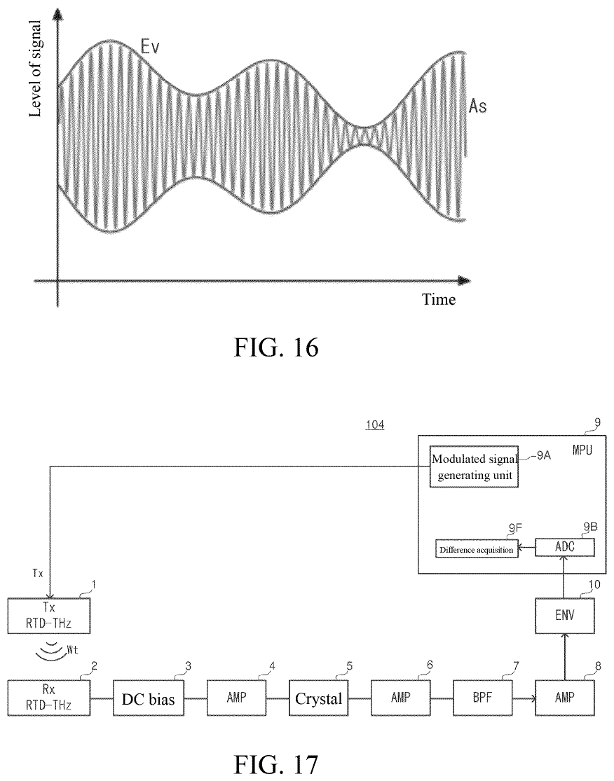

The envelope detection circuit 10 is, for example, in a configuration shown in FIG. 15. In the configuration example in FIG. 15, the envelope detection circuit 10 includes a diode 10A, a capacitor 10B and a resistor 10C. A parallel circuit including the capacitor 10B and the resistor 10C is connected to a cathode of the diode 10A. An anode of the diode 10A becomes an input side, and the cathode of the diode 10A becomes an output side.

As shown by the examples of waveforms in FIG. 16, an envelope Ev in an output waveform As of the amplifier 8 is detected and output to the ADC 9B by the envelope detection circuit 10. That is to say, the envelope Ev converts an output signal of the amplifier 8 to a DC signal, and treats a level of the DC signal as a signal strength. Thus, no frequency analysis unit is needed in the MPU 9.

Moreover, similar to the third embodiment, when the modulated signal Tx is turned on and turned off in this embodiment, the difference acquisition unit 9F is provided in the MPU 9 as shown in FIG. 17. In this case, a first envelope is obtained by detecting the envelope Ev by the envelope detection circuit 10 for a part of the receiving signal Rx corresponding to an ON part of the modulated signal Tx, a second envelope is obtained by detecting the envelope Ev by the envelope detection circuit 10 for a part of the receiving signal Rx corresponding to an OFF part of the modulated signal Tx, and a difference between the first envelope and the second envelope is obtained by the difference acquisition unit 9F. The difference is treated as a signal strength.

### 6. Other

In addition to the embodiments, various modifications may be made to the technical features disclosed by the present disclosure without departing from the scope of the technical inventive subject thereof. That is to say, it should be understood that all aspects of the embodiments are illustrative rather than restrictive, and it should also be understood that the technical scope of the present disclosure is not limited to the embodiments, but includes all modifications of equivalent meanings belonging to the claims within the scope.

### 7. Notes

As described above, for example, a transceiving device (101) of the present disclosure is configured to include:
a modulated signal generating unit (9A), configured to generate a modulated signal (Tx):
a transmitting unit (1), configured to be driven by the modulated signal;
a receiving unit (2), configured to receive a transmission signal (Wt) transmitted from the transmitting unit; and
a crystal filter (5), configured to receive a receiving signal (Rx) output from the receiving unit and including a crystal resonator, wherein
the modulated signal is a sweep signal that changes between a predetermined first frequency (f1) higher than a resonant frequency (fr) of the crystal filter and a predetermined second frequency (f2) lower than the resonant frequency (a first configuration, FIG. 6).

The first configuration can also be configured as, wherein a central frequency (f0) between the first frequency (f1) and the second frequency (f2) is the resonant frequency (fr) (a second configuration).

The first or second configuration can also be configured as, wherein the modulated signal (Tx) is a sine wave signal or a square wave signal (a third configuration).

Any one of the first to third configurations can also be configured as further comprising:
a frequency analysis unit (9C), configured to perform frequency analysis on a signal based on an output of the crystal filter (5), wherein
a power spectral value of a frequency of the modulated signal obtained by the frequency analysis unit is treated as a signal strength (a fourth configuration).

The fourth configuration can also be configured as further comprising:
a frequency adjustment unit (9D), based on a frequency at which the power spectral value obtained by the frequency analysis unit as a peak upon transmission and receipt of the modulated signal in a predetermined sweep range, configured to detect a deviation from the central frequency in the sweep range and adjust the central frequency according to the detected deviation, wherein
the modulated signal generating unit is configured to generate the modulated signal in a range narrower than the sweep range at the central frequency after adjustment (a fifth configuration, FIG. 11).

The fifth configuration can also be configured as, wherein the modulated signal in the range narrower than the sweep range is a fixed frequency signal (a sixth configuration).

Any one of the first to third configurations can also be configured as, wherein the modulated signal generating unit (9A) is configured to turn on and off the modulated signal (a seventh configuration, FIG. 12).

The seventh configuration can also be configured as further comprising:
a frequency analysis unit (9C), configured to perform frequency analysis on a signal based on an output of the crystal filter (5); and
a difference acquisition unit (9E), wherein
first frequency analysis result is obtained by performing frequency analysis using the frequency analysis unit for a part of the receiving signal corresponding to an ON part of the modulated signal,
a second frequency analysis result is obtained by performing frequency analysis using the frequency analysis unit for a part of the receiving signal corresponding to an OFF part of the modulated signal,
the difference acquisition unit is configured to obtain a difference between a power spectral value of a frequency of the modulated signal according to the first frequency analysis result and a power spectral value of a frequency of the modulated signal according to the second frequency analysis result, as a signal strength (an eighth configuration).

Any one of the first to third configurations can also be configured as further comprising:
an envelope detection circuit (10), configured to detect an envelope according to a signal based on an output of the crystal filter (5), wherein a signal strength is obtained based on the envelope (a ninth configuration, FIG. 14).

The ninth configuration can also be configured as further comprising a difference acquisition unit (9E), wherein
the modulated signal generating unit (9A) is configured to turn on and off the modulated signal, and
the difference acquisition unit is configured to obtain a difference between a first envelope obtained by the envelope detection circuit (10) for a part of the receiving signal corresponding to an ON part of the modulated signal and a second envelope obtained by the envelope detection circuit for a part of the receiving signal corresponding to an OFF part of the modulated signal (a tenth configuration, FIG. 17).

Any one of the first to tenth configurations can also be configured as, wherein each of the transmitting unit (1) and the receiving unit (2) includes a resonant-tunneling diode, and
in the modulated signal (Tx), a lower limit voltage (V1) is set to a voltage at which a terahertz wave is not transmitted, and a upper limit voltage (V2) is set to a voltage at which a terahertz wave is transmitted (an eleventh configuration, FIG. 3).

### INDUSTRIAL APPLICABILITY

The present disclosure is, for example, applicable to sensors for various purposes.

1. A transceiving device, comprising:
a modulated signal generating unit, configured to generate a modulated signal;
a transmitting unit, configured to be driven by the modulated signal;
a receiving unit, configured to receive a transmission signal transmitted from the transmitting unit; and
a crystal filter, configured to receive a receiving signal output from the receiving unit and including a crystal resonator, wherein
the modulated signal is a sweep signal that changes between a predetermined first frequency higher than a resonant frequency of the crystal filter and a predetermined second frequency lower than the resonant frequency.

2. The transceiving device of claim 1, wherein a central frequency between the first frequency and the second frequency is the resonant frequency.

3. The transceiving device of claim 1, wherein the modulated signal is a sine wave signal or a square wave signal.

4. The transceiving device of claim 1, further comprising:
a frequency analysis unit, configured to perform frequency analysis on a signal based on an output of the crystal filter, wherein
a power spectral value of a frequency of the modulated signal obtained by the frequency analysis unit is treated as a signal strength.

5. The transceiving device of claim 4, further comprising:
a frequency adjustment unit, based on a frequency at which the power spectral value obtained by the frequency analysis unit as a peak upon transmission and receipt of the modulated signal in a predetermined sweep range, configured to detect a deviation from the central frequency in the sweep range and adjust the central frequency according to the detected deviation, wherein
the modulated signal generating unit is configured to generate the modulated signal in a range narrower than the sweep range at the central frequency after adjustment.

6. The transceiving device of claim 5, wherein the modulated signal in the range narrower than the sweep range is a fixed frequency signal.

7. The transceiving device of claim 1, wherein the modulated signal generating unit is configured to turn on and off the modulated signal.

8. The transceiving device of claim 7, further comprising:
a frequency analysis unit, configured to perform frequency analysis on a signal based on an output of the crystal filter; and
a difference acquisition unit, wherein
a first frequency analysis result is obtained by performing frequency analysis using the frequency analysis unit for a part of the receiving signal corresponding to an ON part of the modulated signal,
a second frequency analysis result is obtained by performing frequency analysis using the frequency analysis unit for a part of the receiving signal corresponding to an OFF part of the modulated signal,
the difference acquisition unit is configured to obtain a difference between a power spectral value of a frequency of the modulated signal according to the first frequency analysis result and a power spectral value of a frequency of the modulated signal according to the second frequency analysis result, as a signal strength.

9. The transceiving device of claim 1, further comprising:
an envelope detection circuit, configured to detect an envelope according to a signal based on an output of the crystal filter, wherein a signal strength is obtained based on the envelope.

10. The transceiving device of claim 9, further comprising:
a difference acquisition unit, wherein
the modulated signal generating unit is configured to turn on and off the modulated signal, and
the difference acquisition unit is configured to obtain a difference between a first envelope obtained by the envelope detection circuit for a part of the receiving signal corresponding to an ON part of the modulated signal and a second envelope obtained by the envelope detection circuit for a part of the receiving signal corresponding to an OFF part of the modulated signal.

11. The transceiving device of claim 1, wherein
each of the transmitting unit and the receiving unit includes a resonant-tunneling diode, and
in the modulated signal, a lower limit voltage is set to a voltage at which a terahertz wave is not transmitted, and a upper limit voltage is set to a voltage at which a terahertz wave is transmitted.
